(19) United States
(12) Patent Application Publication
(10) Pub. No.: US 2015/0334309 A1
(43) Pub. Date: Nov. 19, 2015

(54) HANDHELD ELECTRONIC APPARATUS, IMAGE CAPTURING APPARATUS AND IMAGE CAPTURING METHOD THEREOF

(71) Applicant: HTC Corporation, Taoyuan City (TW)

(72) Inventors: Yu-Chun Peng, Taoyuan City (TW); Wei-Feng Chien, Taoyuan City (TW); Gordon Horng, Taoyuan City (TW)

(21) Appl. No.: 14/585,185

(22) Filed: Dec. 30, 2014

Related U.S. Application Data
(60) Provisional application No. 61/994,141, filed on May 16, 2014.
(60) Provisional application No. 62/014,127, filed on Jun. 19, 2014.

(51) Int. Cl. H04N 5/232; H04N 5/265; H04N 13/02

(52) U.S. Cl. CPC H04N 5/23296; H04N 13/0242; H04N 5/265

(57) ABSTRACT

The invention provides an electronic apparatus, an image capturing apparatus and an image capturing method thereof. The image capturing apparatus includes a main camera, a tele camera, a depth camera, and a processing unit. The main camera is used for capturing a main image, the tele camera is used for capturing a tele image, and the depth camera is used for capturing a depth image. The processing unit is coupled to the main, tele, and depth cameras. The processing unit is used for: combining the main image and the tele image to obtain a zoomed image; and generate a depth map corresponding to the zoomed image based on the main image, the tele image, and the depth image.

### CROSS-REFERENCE TO RELATED APPLICATION

This application claims the priority benefits of U.S. provisional application Ser. No. 61/994,141, filed on May 16, 2014, and U.S. provisional application Ser. No. 62/014,127, filed on Jun. 19, 2014. The entirety of each of the above-mentioned patent applications is hereby incorporated by reference herein and made a part of this specification.

### BACKGROUND

1. Field of the Invention

The invention relates to an image capturing apparatus and an image capturing method thereof. Particularly, the invention relates to the image capturing apparatus and the image capturing method thereof for obtaining a depth map of a zoomed image.

2. Description of Related Art

With advancement of electronic technologies, handheld electronic apparatuses have become an important tool in daily lives. A handheld electronic apparatus is usually disposed with an image capturing apparatus which is now a standard equipment for the handheld electronic apparatus.

For improving the efficiency of the image capturing apparatus in the handheld electronic apparatus, more display function for the captured image are needed. For an example, to perform a zoomed image display on the handheld electronic apparatus. That is, for performing a zoomed image with good image quality, a precisely depth map corresponding to the zoomed image is also needed.

### SUMMARY OF THE INVENTION

The invention is directed to a handheld electronic apparatus, an image capturing apparatus and an image capturing method thereof for obtaining a depth map of a zoomed image.

The invention provides an image capturing apparatus including a main camera, a tele camera, a depth camera, and a processing unit. The main camera is used for capturing a main image, the tele camera is used for capturing a tele image, and the depth camera is used for capturing a depth image. The processing unit is coupled to the main, tele, and depth cameras. The processing unit is used for combining the main image and the tele image to obtain a zoomed image; and generate a depth map corresponding to the zoomed image based on the main image, the tele image, and the depth image.

The invention provides a handheld electronic apparatus including a housing, a main camera, a tele camera, a depth camera, and a processing unit. The housing has a front side and a back side. The main camera is used for capturing a main image, wherein the main camera is mounted in the housing and disposed on the back side. The tele camera is used for capturing a tele image, wherein the tele camera is mounted in the housing and disposed on the back side. The depth camera is used for capturing a depth image, wherein the depth camera is mounted in the housing and disposed on the back side. The processing unit is coupled to the main, tele and depth cameras, and is configured for combining the main image and the tele image to obtain a zoomed image; and generate a depth map corresponding to the zoomed image based on the main image, the tele image, and the depth image.

The invention provides an image capture method, and the steps of the method includes capturing a main image, a tele image and a depth image, respectively; combining the main image and the tele image to obtain a zoomed image; and generating a depth map corresponding to the zoomed image based on the main image, the tele image, and the depth image.

According to the above descriptions, in the invention, the main and tele cameras are providing for obtaining zoomed image. The depth camera is provided for obtaining a depth map. The depth map corresponding to the zoomed image can be obtained based on a main image, a tele image and a depth image which are respectively obtained by the main, tele, and depth cameras. That is, the depth map can be obtained precisely, and the zoomed image can be performed well by the image capturing apparatus.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a structure diagram of a handheld electronic apparatus 100 according to an embodiment of the present application.

FIG. 2 is a structure diagram of an image capturing apparatus of a handheld electronic apparatus according to an embodiment of the present application.

FIG. 3 illustrates a method for obtaining the depth map according to an embodiment of present application.

FIG. 4 illustrates field of view (FOV) of main and tele cameras according to embodiments of present application.

FIGS. 5A, 5C and 5D are a block diagram of an image capturing apparatus according to an embodiment of present application.

FIG. 5B is a block diagram of an image capturing apparatus according to another embodiment of present application.

FIG. 6 is arrangement of cameras according to an embodiment of present application.

FIG. 7 is a flow chart of steps of the image capturing method according to an embodiment of present application.

FIG. 8 illustrates a flow chart of the steps for obtaining the depth map according to an embodiment of present application.

### DETAILED DESCRIPTION OF DISCLOSED EMBODIMENTS

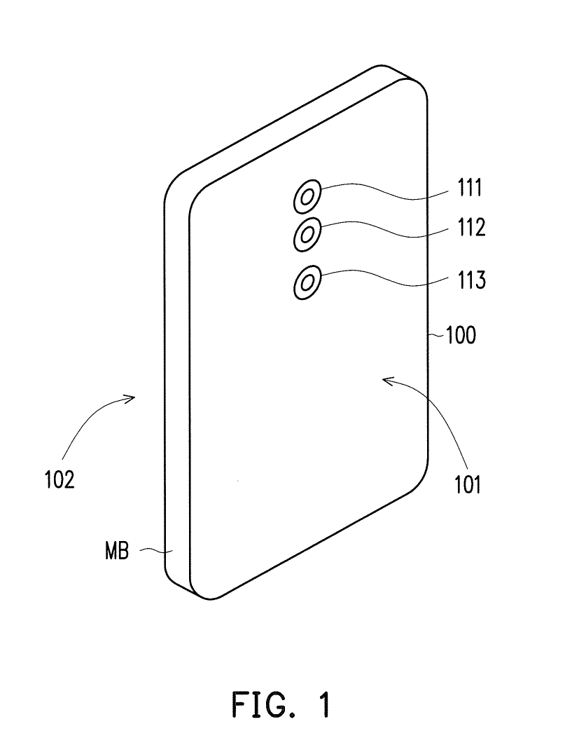

Please referring to FIG. 1, FIG. 1 is a structure diagram of a handheld electronic apparatus 100 according to an embodiment of the present application. The handheld electronic apparatus 100 has a housing MB. The housing MB has a front side 102 and a back side 101, and a main, tele and depth cameras 111, 112 and 113 are mounted in the housing MB and are disposed on the back side 101. The handheld electronic apparatus 100 may be a smart phone.

The main camera 111 is neighbored to the tele camera 112, and the tele camera 112 is neighbored to the depth camera 113. In FIG. 1, the depth camera 112 is disposed between the main camera 111 and the depth camera 113, and the main, tele and depth cameras 111, 112 and 113 can be arranged in a straight line.

A processing unit is disposed in the handheld electronic apparatus 100. The processing unit is coupled to the main, tele and depth cameras 111, 112 and 113. The main, tele and depth cameras 111, 112 and 113 may used to capture a main, tele and depth images respectively. The processing unit can comprise a zooming engine for operating on the first and second images which are respectively obtained by the main, and tele cameras 111 and 112. The processing unit can further comprise a depth engine for obtain a depth map according to the third image which is captured by the depth camera 113 and at least one of the main and tele images.

Furthermore, the main camera 111, the tele camera 112, and the depth camera 113 may be configured to photograph in synchronization to capture the main image, the tele image, and the depth image. Or, the main camera 111, the tele camera 112, and the depth camera 113 may be configured to photograph in non-synchronization to capture the main image, the tele image, and the depth image.

The processing unit may generate a zoomed image by the zooming operation. A controller of the handheld electronic apparatus 100 may generate an output image according to the zoomed image and the depth map.

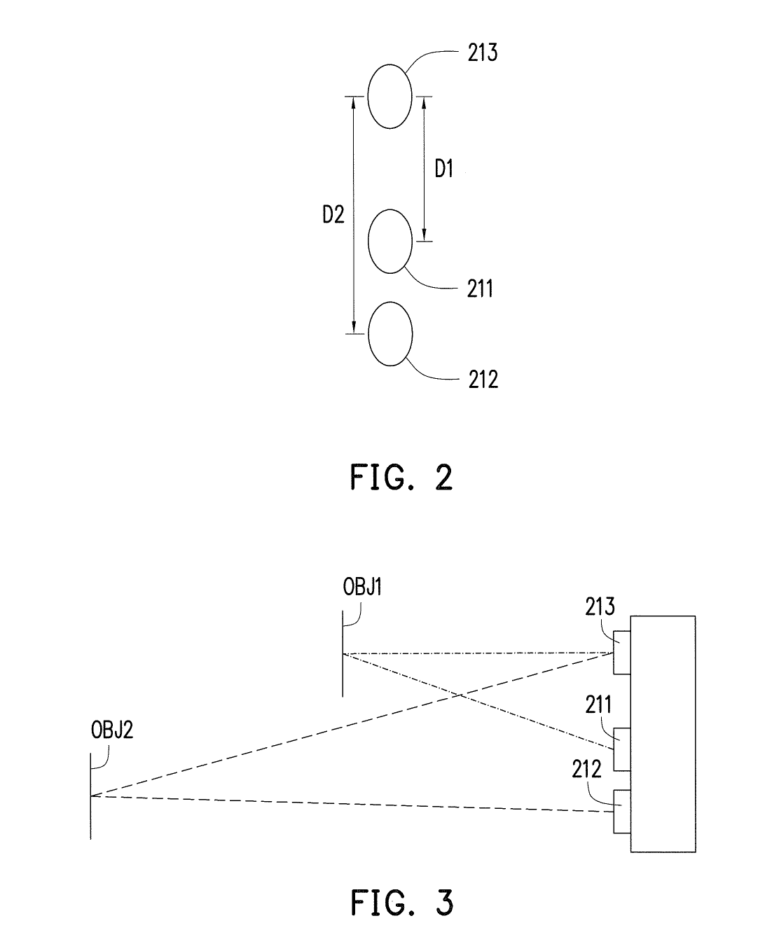

Referring to FIG. 2, FIG. 2 is a structure diagram of an image capturing apparatus of a handheld electronic apparatus according to an embodiment of the present application. In FIG. 2, main, tele and depth cameras 211-213 are disposed in a surface of an electronic apparatus. A distance D1 between the main camera 211 and the depth camera 213 is less than a distance D2 between the tele camera 212 and the depth camera 213. The main camera 211 and the tele camera 212 provide main and tele images respectively for zooming operation.

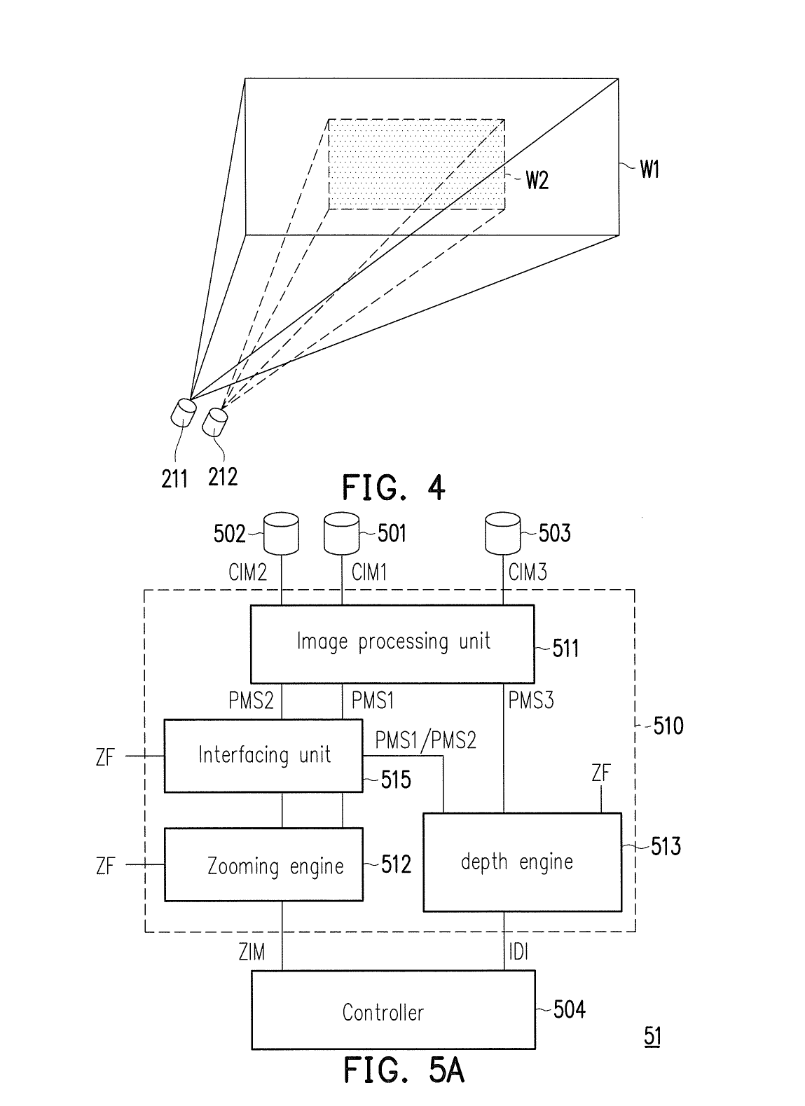

Please referring to FIG. 4, FIG. 4 illustrates field of view (FOV) of main and tele cameras according to embodiments of present application. Please notice here, an effective focal length of the main camera 211 is smaller than an effective focal length of the tele camera 212, and an area of the FOV W2 of the tele camera 212 is smaller than an FOV W1 of the main camera 211. Also, the FOV W1 covers the FOV W2, and the geometry centers of the FOV W1 and W2 are not overlapped. Besides, an effective focal length of the depth camera 213 may be smaller than the effective focal length of the main camera 211, and a FOV of the depth camera 213 is larger than and may cover the FOV W1 and W2.

When a zooming operation (zoom-in) is executed in the handheld electronic apparatus, an interpolation operation may be operated by the processing unit according to the first image and second image which are respectively captured by the main and tele cameras 211 and 212. Besides, the main and tele cameras 211 and 212 need to be close to each other, and the first and second cameras 211 and 212 can be combined on a same substrate, or can be separated modules and combined by mechanical fixture.

In FIG. 2, the depth camera 213 is used for obtaining depth map. The processing unit may use an image of the third camera 213 and one of image obtained by at least one of the main and tele cameras 211 and 212. For example, for an object with near distance, the images of the depth camera 213 and the main camera 211 are used for calculating the depth map. On the other hand, for an object with far distance, the images of the depth camera 213 and the tele camera 212 are used for calculating the depth map.

The processing unit may select at least one of the cameras 211 and 212 for the depth map calculation according to a zooming factor. The zooming factor may be set by user, and if the zooming factor is less than a first threshold value, the processing unit may select by the first and third cameras 211 and 213. On the contrary, if the zooming factor is larger than a second threshold value, the processing unit may select by the tele and depth cameras 212 and 213. Wherein, the first threshold value is not larger than the second threshold value.

If the first threshold value is different from (less than) the second threshold value, and when the zooming factor is between the first and second threshold values, the processing unit may select both images of the main and tele cameras 211 and 212 for calculating the depth map with the image of the depth camera 213.

On the other hand, the processing unit may calculate a short range parallax information by comparing the depth image and the main image, and calculate a long range parallax information by comparing the depth image and the tele image. Furthermore, the processing unit selectively adopts the short range parallax information or the long range parallax information to generate the depth map.

About the zooming operation, the processing unit receives a zooming factor, and crops the main image based on the zooming factor to obtain a cropped main image. Then, the processing unit enhances the cropped main image by referencing the tele image to obtain the zoomed image.

Please referring to FIG. 3, FIG. 3 illustrates a method for obtaining the depth map according to an embodiment of present application. By different zooming factor, if the object OBJ1 has a near object distance, the images of the third and first cameras 213 and 211 are used for depth map calculation. If the object OBJ2 has a far object distance, the images of the depth and tele cameras 213 and 212 are used for depth map calculation. Since the distance between the main and depth cameras 211 and 213 is less than the distance between the second and third cameras 212 and 213. That is, by according to the second and third cameras 212 and 213 with larger distance, the depth map can be obtained precisely. The output image with high performance can be obtained correspondingly.

In briefly, if the image depth of the object is less than 20 cm, the first and third cameras 211 and 213 may be used for calculating the image depth, and if the image depth of the object is between 20 cm to 2 m, the tele and depth cameras 212 and 213 may be used for calculating the image depth.

In detail about the depth map, the processing unit is configured to search a target object in the main image, the tele image, and the depth image, and calculate the short range parallax exists between the target object on the depth image and the main image. Moreover, the processing unit calculates the long range parallax exists between the target object on the depth image and the tele image and estimates an object distance corresponding to a distance between the target object and the image capturing apparatus based on the short range parallax or the long range parallax. The depth map can be generated based on the estimated object distance. Please note here, the processing unit estimates the object distance based on the short range parallax if the focus factor is set within a first threshold value. And, the processing unit estimates the object distance based on the long range parallax if the focus factor is set beyond a second threshold value. The first and second threshold values may be determined by a designer of the image capturing apparatus.

In fact, there are many objects in an image, and object distance of the objects may be different. The processing unit may search the multiple target objects in the main image, the tele image, and the depth image, and calculate a short range parallax exists between the depth image and the main image. Further, the processing unit may calculate a long range parallax exists between the depth image and the tele image, estimate a first set of object distance corresponding to the distance between the multiple target object and the image capturing apparatus based on the short range parallax and the long range parallax, and estimate a second set of object distance corresponding to the distance between the multiple target object and the image capturing apparatus based on the long range parallax. The processing unit can choose from the first set of object distances and the second set of object distances to obtain an optimized set of object distances.

Besides, the processing unit may transfer both of the depth image and the zoomed image to YUV format, and calculate the depth map according to the depth image and the zoomed image with YUV format.

In some embodiment of present application, all of the main, tele and depth cameras 211-213 are used for depth map calculation, especially for the object having a middle image depth.

It should be noted here, resolutions of the main, tele and depth cameras may be the same.

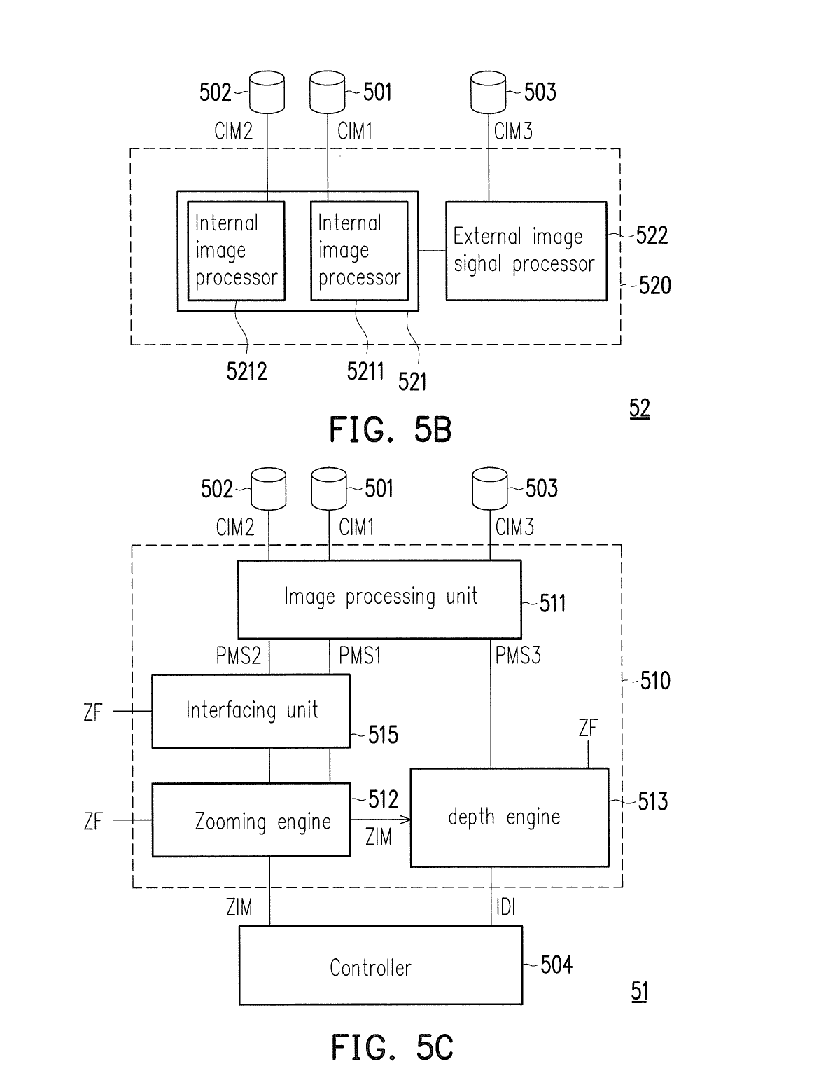

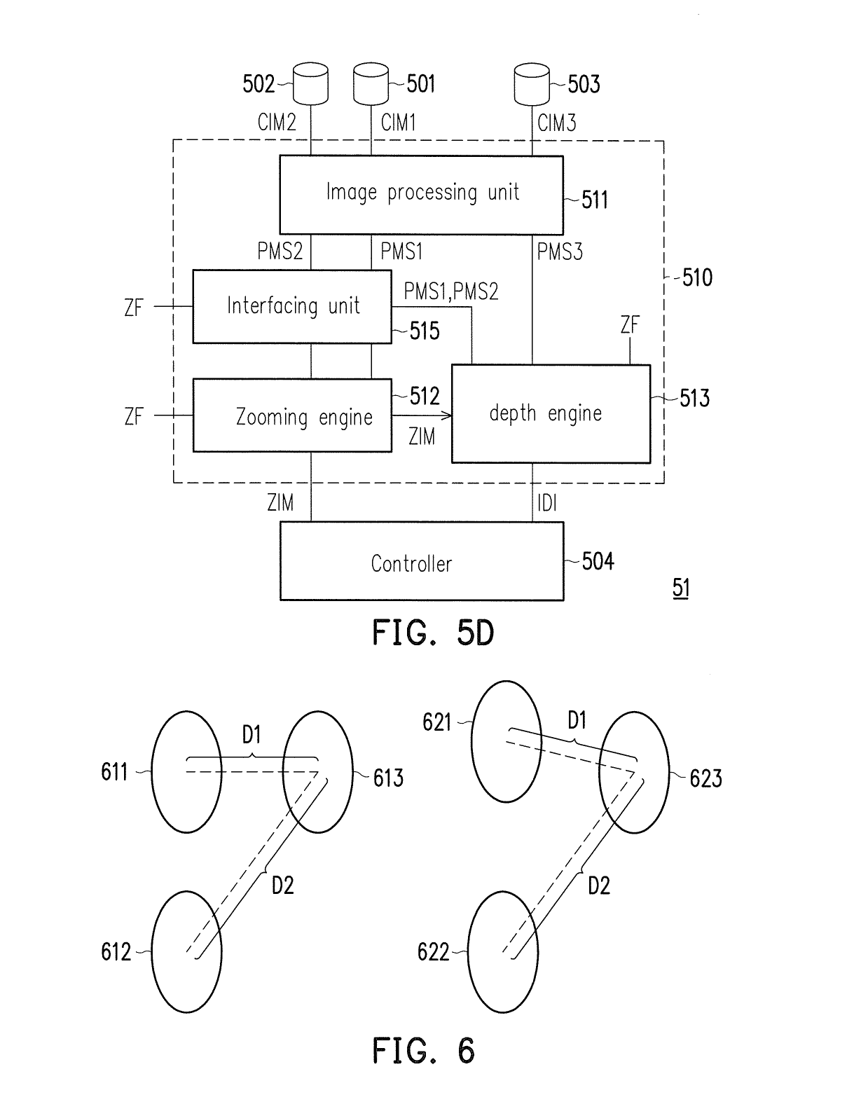

Please referring to FIGS. 5A, 5C and 5D, FIGS. 5A, 5C and 5D are a block diagrams of an image capturing apparatus according to an embodiment of present application. The image capturing apparatus 51 includes a main camera 501, a tele camera 502, a depth camera 503, a processing unit 510 and a controller 504. The processing unit 510 is coupled to the main, tele and depth cameras 501, 502 and 503. A distance between the main camera 501 and the depth camera 503 is less than a distance between the tele camera 502 and the depth camera 503. The main, tele and depth cameras 501-503 capture a main, tele and depth images CIM1, CIM2 and CIM3 respectively. The processing unit 510 receives a zooming factor ZF, and the processing unit 510 operates the zooming operating on the images CIM1 and CIM2 which are respectively obtained by the main and tele cameras 501 and 502 according to the zooming factor ZF to obtain a zoomed image ZIM.

The processing unit 510 includes an image processing unit 511, an interfacing unit 515, a zooming engine 512, and a depth engine 513. The image processing unit 511 is coupled to the main, tele and depth cameras 501-503 and receives the main, tele and depth images CIM1-CIM3 which are generated by the main, tele and depth cameras 501-503 respectively. The image processing unit 511 operates signal processing on the signal of the main, tele and depth image CIM1-CIM3 and generates the processed main, tele and depth image PMS1-PMS3 respectively.

The interfacing unit 515 is coupled to the image processing unit 511, and receives the processed main and tele images PMS1-PMS2 and the zooming factor ZF. In FIG. 5A, the interfacing unit 515 transports one of the processed main and tele images PMS1-PMS2 to the depth engine 513 according to the zooming factor ZF. In detail, if the zooming factor ZF is larger than a threshold value, the interfacing unit 515 may transport the first processed image signal PMS 1 to the depth engine 513, and if the zooming factor ZF is less than the threshold value, the interfacing unit 515 may transport the second processed image signal PMS2 to the depth engine 513.

On the other hand, the interfacing unit 515 also transports the processed main and tele images PMS1 and PMS2 to the zooming engine 512. The zooming engine 512 operates a zooming operation (e.g., Zoom-in operation) on the processed main and tele images PMS1 and PMS2 according to the zooming factor ZF for generating the zoomed image ZIM.

The zooming engine 512 is configured to create the zoomed image by interlacing the tele image and the main image.

The depth engine 513 receives one of the processed main and tele images PMS1 and PMS2, the processed depth image signal PMS3, and the zooming factor ZF1. If the processed main image PMS 1 is transported to the depth engine 513, the depth engine 513 calculates the depth map IDI according to the processed main and depth images PMS1 and PMS3. On the contrary, if the processed tele image signals PMS2 is transported to the depth engine 513, the depth engine 513 calculates the depth map IDI according to the processed tele and depth images PMS2 and PMS3.

Of course, in some embodiment, the interfacing unit 515 may transport both of the processed main and tele images PMS1 and PMS2 according to the zooming factor ZF. The depth engine 513 may obtain the depth map IDI according to the processed main, tele and depth images PMS1, PMS2 and PMS3.

In detail, the depth engine 513 may be configured to calculate an object distance of at least one area of the zoomed image ZIM from the zooming engine 512 based on a zoom parallax between the zoomed image ZIM and the depth image PMS3, and to create the depth map based on the calculated object distance (referring to FIG. 5C). Moreover, the depth engine 513 may be configured to calculate an object distance of at least one area of at least one of the main and tele images PMS1 and PMS2 based on a zoom parallax between at least one of the main and tele images PMS1 and PMS2 and the depth image PMS3, and to create the depth map based on the calculated object distance (referring to FIG. 5A). On the other hand, the depth engine 513 may also be configured to calculate a first object distance of at least one area of the main image PMS1 based on a zoom parallax between the main image PMS1 and the depth image PMS3, and calculate a second object distance of at least one area of the tele image PMS2 based on the zoom parallax between the tele image PMS2 and the depth image PMS3, the depth engine 513 is further configured to create the depth map based on the first and second object distances (referring to FIG. 5D).

That is, the depth engine 513 may obtain the depth map according the depth image PMS3 and at least one of the main, tele, and zoomed images PMS1, PMS2 and ZIM. The depth map is obtained by the depth image PMS3 and any one or more images of the main, tele, and zoomed images PMS1, PMS2 and ZIM. An optimum depth map can be obtained.

The controller 504 is coupled to the zooming engine unit 512 and the depth engine 513. The controller 504 receives the zoomed image ZIM and the depth map IDI, and generates an output image OI according to the zoomed image ZIM and the depth map IDI.

Please referring to FIG. 5B, FIG. 5B is a block diagram of an image capturing apparatus according to another embodiment of present application. In FIG. 5B, the image capturing apparatus 52 includes a main camera 501, a tele camera 502, a depth camera 503 and a processing unit 520. The processing unit 520 includes an application processor 521 and an external image signal processor 522. The application processor 521 includes two internal image processors 5211 and 5212. The internal image processors 5211 and 5212 are respectively connected to the main and tele cameras 501 and 502, and are used to receive the main image CIM1 and the tele image CIM2 respectively. The internal image processors 5211 and 5212 operates image processing on the main and tele images CIM1 and CIM2 respectively. The application processor 521 creates the zoomed image based on the main and tele images CIM1 and COM2 which are respectively processed by the internal image processors 5211 and 5212.

The external image signal processor 522 connected between the depth camera 503 and the application processor 521. The external image signal processor 522 is configured to receive the depth image CIM3

Referring to FIG. 6, FIG. 6 is arrangement of cameras according to an embodiment of present application. In FIG. 6, the first, second and third cameras 611, 612 and 613 may be arranged in L-shape. The distance D1 between the main and depth cameras 611 and 613 is smaller than the distance D2 between the tele and depth cameras 612 and 613. Also, in another embodiment, the main, tele and depth cameras 621, 622 and 623 are arranged in a triangle. The distance D1 between the main and depth cameras 621 and 623 is smaller than the distance D2 between the tele and depth cameras 622 and 623.

Of course, in some embodiments, the main, tele and depth cameras may be arranged with other shape. The point is, a distance between the main and depth cameras should be smaller than a distance between the tele and depth cameras.

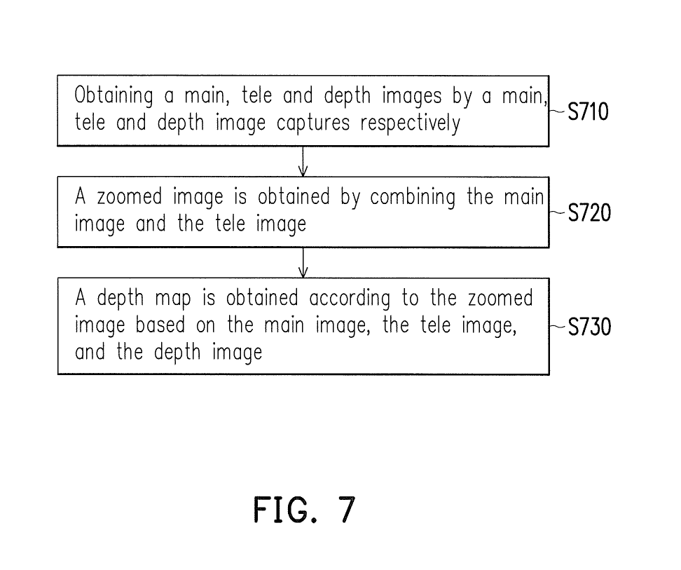

Please referring to FIG. 7, FIG. 7 is a flow chart of steps of the image capturing method according to an embodiment of present application. In step S710, a main, tele and depth images are obtained by a main, tele and depth cameras respectively. Here, a distance between of the first and third cameras is less than a distance between the second and the third cameras. In step S720, a zoomed image is obtained by combining the main image and the tele image. In step S730, a depth map is obtained according to the zoomed image based on the main image, the tele image, and the depth image. An output image can be obtained according to the zoomed image and the depth map. Moreover, the detail operation of each of the steps S710-S730 can be referred to the embodiments in FIG. 1-FIG. 6B.

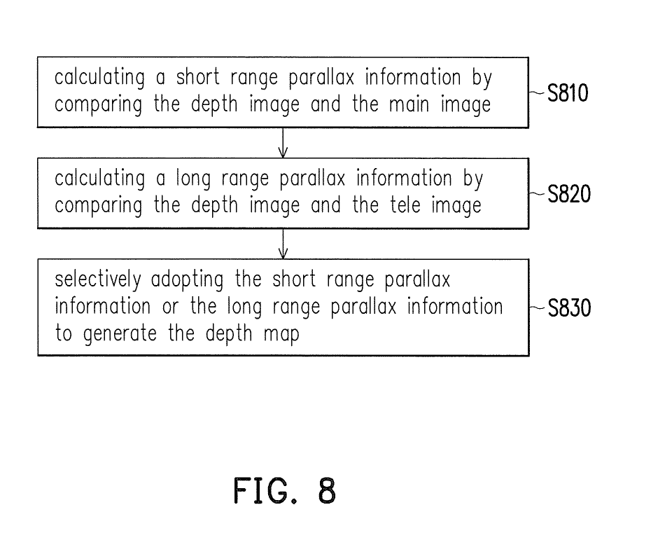

Please referring to FIG. 8, FIG. 8 illustrates a flow chart of the steps for obtaining the depth map according to an embodiment of present application. In step S810, a short range parallax information is calculated by comparing a depth image and a main image, wherein the depth image and the main image are respectively obtained by a depth camera and a main camera. In step S820, a long range parallax information is calculated by comparing the depth image and a tele image, wherein the tele image is obtained by a tele camera. Furthermore, in step S830, the short and long range parallax information are selectively adapted to generate the depth map.

It should be noted here, the executing sequence of the step S810 and S820 are not limited. In some embodiment, the step S810 may be executed before the step S820, or the step S810 may be executed after the step S820. Furthermore, the steps S810 and S820 may be executed simultaneously.

In summary, the main, tele and depth images are respectively obtained by the main, tele and depth image cameras. The zoomed image may be obtained based on the main and tele images. The depth map may be obtained based on the main, tele and depth images. In the present disclosure, the depth map may be calculated according to at least two of the main, tele and depth images. Accordingly, the depth map with high accuracy can be obtained.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An image capturing apparatus, comprising:
a main camera, for capturing a main image;
a tele camera, for capturing a tele image;
a depth camera, for capturing a depth image; and
a processing unit, coupled to the main, tele and depth cameras, for:
combining the main image and the tele image to obtain a zoomed image;
generate a depth map corresponding to the zoomed image based on the main image, the tele image, and the depth image.

2. The image capturing apparatus according to claim 1, wherein the processing unit is for:
calculating a short range parallax information by comparing the depth image and the main image;
calculating a long range parallax information by comparing the depth image and the tele image; and
selectively adopting the short range parallax information or the long range parallax information to generate the depth map.

3. The image capturing apparatus according to claim 1, further comprises a housing having a front side and a back side, wherein the tele camera, the main camera, and the depth camera are mounted in the housing and disposed on the back side.

4. The image capturing apparatus according to claim 1, wherein a field of view (FOV) of the tele camera is covered by a FOV of the main camera, and the FOV of the main camera is covered by a FOV of the depth camera.

5. The image capturing apparatus according to claim 1, wherein the processing unit comprises:
an application processor, comprises a first internal image signal processor, connected to the tele camera for receiving the tele image, and a second internal image signal processor, connected to main camera, for receiving the main image; wherein the application processor is configured to create the zoomed image based on the tele image and the main image; and
an external image signal processor, connected between the depth camera and the application processor, configured to receive the depth image.

6. The image capturing apparatus according to claim 5, wherein the zoomed image and the depth image are transformed into YUV format.

7. The image capturing apparatus according to claim 1, wherein the processor further comprises:
a zooming engine, configure to create the zoomed image by interlacing the tele image and the main image; and
a depth engine, configure to obtain the depth map according to the depth image and at least one of the main and tele images.

8. The image capturing apparatus according to claim 7, wherein the depth engine is configured to calculate an object distance of at least one area of the zoomed image based on a zoom parallax between the zoomed image and the depth image, and to create the depth map based on the calculated object distance.

9. The image capturing apparatus according to claim 7, wherein the depth engine is configured to calculate an object distance of at least one area of at least one of the main and tele images based on a zoom parallax between at least one of the main and tele images and the depth image, and to create the depth map based on the calculated object distance.

10. The image capturing apparatus according to claim 7, wherein the depth engine is configured to calculate a first object distance of at least one area of the main image based on a zoom parallax between the main image and the depth image, and calculate a second object distance of at least one area of the tele image based on the zoom parallax between the tele image and the depth image, the depth engine is further configured to create the depth map based on the first and second object distances.

11. The image capturing apparatus according to claim 7, wherein the processing unit further comprises:
an image signal processing unit, receiving the main, tele and depth images, and operating a signal processing operation on the main, tele and depth images, the image signal processing unit transports a processed main image and a processed tele image to the zooming engine and transports a processed depth image and at least one of the processed main and tele images to the depth engine.

12. The image capturing apparatus according to claim 11, wherein the image signal processing unit comprises:
a first signal processor, coupled to the main camera, wherein the first signal processor processes the main image to obtain the processed main image;
a second signal processor, coupled to the tele camera, wherein the second signal processor processes the tele image to obtain the processed tele image; and
a third signal processor, coupled to the depth camera, wherein the third signal processor processes the depth image to obtain the processed depth image.

13. The image capturing apparatus according to claim 11, wherein the processing unit further comprises:
an interfacing unit, coupled between the image signal processing unit, the zooming engine, and the depth engine, wherein the interfacing unit receives a zooming factor and transports at least one of the main and tele processed images to the depth engine according to the zooming factor.

14. The image capturing apparatus according to claim 11, further comprising:
a controller, coupled to the zooming engine and the depth engine, wherein the controller generates an output image according to the zoomed image and the depth map.

15. The image capturing apparatus according to claim 1, wherein a distance between of the main and tele cameras is less than a distance between the tele and the depth cameras.

16. The image capturing apparatus according to claim 15, wherein the main camera is closely neighbored to the tele camera at a first distance and neighbored to the depth camera at a second distance, and the first distance is substantially smaller than the second distance, and thus a parallax between the main image and the tele image is substantially smaller than a parallax between the depth image and the main image.

17. The image capturing apparatus according to claim 1, wherein an effective focal length of the main camera is smaller than an effective focal length of the tele camera.

18. The image capturing apparatus according to claim 1, wherein the processing unit configured to:
receive a zooming factor;
crop the main image based on the zooming factor to obtain a cropped main image; and
enhance the cropped main image by referencing the tele image to obtain the zoomed image.

19. The image capturing apparatus according to claim 1, wherein the main camera, the tele camera, and the depth camera are configured to photograph in synchronization to capture the main image, the tele image, and the depth image.

20. The image capturing apparatus according to claim 2, wherein the processing unit is configured to:
search a target object in the main image, the tele image, and the depth image;
calculate the short range parallax exists between the target object on the depth image and the main image;
calculate the long range parallax exists between the target object on the depth image and the tele image;
estimate an object distance corresponding to a distance between the target object and the image capturing apparatus based on the short range parallax or the long range parallax; and
generate the depth map based on the estimated object distance.

21. The image capturing apparatus according to claim 19, wherein the processing unit estimate the object distance based on the short range parallax if the focus factor is set within a first threshold value.

22. The image capturing apparatus according to claim 21, wherein the processing unit estimate the object distance based on the long range parallax if the focus factor is set beyond a second threshold value.

23. The image capturing apparatus according to claim 1, wherein the processing unit is configured to:
search multiple target objects in the main image, the tele image, and the depth image;
calculate a short range parallax exists between the depth image and the main image;
calculate a long range parallax exists between the depth image and the tele image;
estimate a first set of object distance corresponding to the distance between the multiple target object and the image capturing apparatus based on the short range parallax and the long range parallax;
estimate a second set of object distance corresponding to the distance between the multiple target object and the image capturing apparatus based on the long range parallax; and
choose from the first set of object distances and the second set of object distances to obtain an optimized set of object distances.

24. The image capturing apparatus according to claim 22, wherein the processing unit obtains the depth map by the first, second and third cameras if the zooming factor is between the first and second threshold values, wherein the first threshold value is less than the second threshold value.

25. The image capturing apparatus according to claim 1, wherein the resolutions of the main, tele and depth cameras are the same.

26. The image capturing apparatus according to claim 1, wherein the main, tele and depth cameras are arranged in a line, a L-shape, or a triangle shape.

27. A handheld electronic apparatus, comprising:
a housing, having a front side and a back side;
a main camera, for capturing a main image, wherein the main camera is mounted in the housing and disposed on the back side;
a tele camera, for capturing a tele image, wherein the tele camera is mounted in the housing and disposed on the back side;
a depth camera, for capturing a depth image, wherein the depth camera is mounted in the housing and disposed on the back side; and
a processing unit, coupled to the main, tele and depth cameras, for:
combining the main image and the tele image to obtain a zoomed image; and
generate a depth map corresponding to the zoomed image based on the main image, the tele image, and the depth image.

28. The handheld electronic apparatus according to the claim 27, wherein the main camera is closely neighbored to the tele camera at a first distance and neighbored to the depth camera at a second distance, and the first distance is substantially smaller than the second distance, and thus a parallax between the main image and the tele image is substantially smaller than a parallax between the depth image and the main image.

29. The handheld electronic apparatus according to claim 28, wherein an effective focal length of the main camera is smaller than an effective focal length of the tele camera.

30. An image capturing method, comprising:
capturing a main image, a tele image and a depth image, respectively;
combining the main image and the tele image to obtain a zoomed image; and
generating a depth map corresponding to the zoomed image based on the main image, the tele image, and the depth image.

31. The image capturing method according to claim 30, wherein the step of generating the depth map corresponding to the zoomed image based on the main image, the tele image, and the depth image comprises:
calculating a short range parallax information by comparing the depth image and the main image;
calculating a long range parallax information by comparing the depth image and the tele image; and
selectively adopting the short range parallax information or the long range parallax information to generate the depth map.

32. The image capturing method according to claim 30, wherein the step of combining the main image and the tele image to obtain the zoomed image comprises:
creating the zoomed image by interlacing the tele image and the main image.

33. The image capturing method according to claim 32, wherein then step of generating the depth map corresponding to the zoomed image based on the main image, the tele image, and the depth image comprises:
calculating an object distance of at least one area of the zoomed image based on a zoom parallax between the zoomed image and the depth image; and
creating the depth map based on the calculated object distance.

34. The image capturing method according to claim 32, wherein then step of generating the depth map corresponding to the zoomed image based on the main image, the tele image, and the depth image comprises:
calculating an object distance of at least one area of at least one of the main and tele images based on a zoom parallax between at least one of the main and tele images and the depth image, and
creating the depth map based on the calculated object distance.

35. The image capturing method according to claim 32, wherein then step of generating the depth map corresponding to the zoomed image based on the main image, the tele image, and the depth image comprises:
calculating a first object distance of at least one area of the main image based on a zoom parallax between the main image and the depth image;
calculating a second object distance of at least one area of the tele image based on the zoom parallax between the tele image and the depth image; and
creating the depth map based on the first and second object distances.
